(19) United States
(12) Patent Application Publication
(10) Pub. No.: US 2023/0026938 A1
(43) Pub. Date: Jan. 26, 2023

(54) METHOD, ELECTRONIC DEVICE, AND COMPUTER PROGRAM PRODUCT FOR SAMPLE MANAGEMENT

(71) Applicant: EMC IP Holding Company LLC, Hopkinton, MA (US)

(72) Inventors: Zijia Wang, WeiFang (CN); Jiacheng Ni, Shanghai (CN); Wenbin Yang, Shanghai (CN); Zhen Jia, Shanghai (CN)

(21) Appl. No.: 17/404,011

(22) Filed: Aug. 17, 2021

(30) Foreign Application Priority Data
Jul. 23, 2021 (CN) 202110836667.5

(51) Int. Cl. G06K 9/62

(52) U.S. Cl. CPC G06K 9/6257; G06K 9/6232; G06K 9/6262; G06K 9/623

(57) ABSTRACT

A method in an illustrative embodiment includes determining a first set of distilled samples from a first set of samples based on a characteristic distribution of the first set of samples, the first set of samples being associated with a first set of classifications. The method also includes acquiring a first set of characteristic representations associated with the first set of distilled samples. The method also includes adjusting the first set of characteristic representations so that a distance between characteristic representations associated with the same classification is less than a predetermined threshold. The method also includes determining, based on the adjusted first set of characteristic representations, a first set of classification characteristics of the first set of samples and associated with the first set of classifications, the classification characteristics being used to characterize a distribution of characteristic representations of samples having corresponding classifications in the first set of samples.

### RELATED APPLICATION(S)

The present application claims priority to Chinese Patent Application No. 202110836667.5, filed Jul. 23, 2021, and entitled “Method, Electronic Device, and Computer Program Product for Sample Management,” which is incorporated by reference herein in its entirety.

### FIELD

Embodiments of the present disclosure relate to the field of computers, and more particularly, to a method, an electronic device, and a computer program product for sample management.

### BACKGROUND

Users in the artificial intelligence industry, such as autonomous driving companies, commonly rely on computing power for processing large amounts of data. Managing data, machine learning models, and basic IT systems is complex and expensive. In this regard, for a sample set for training, it is desirable that a training set that includes a large number of samples can be transformed to a training set including only a small number of samples, and also there is a need to ensure that the training set obtained by the transformation should be able to achieve the same training effect as the original training set. For reduction of a training set, a sample set can be distilled conventionally so as to obtain a sample set including a very small number of samples, thereby replacing the original sample set with the distilled sample set for use in machine learning training.

### SUMMARY

Embodiments of the present disclosure provide a solution for performing sample management using distilled samples.

In a first aspect of the present disclosure, a method for sample management is provided. The method includes determining a first set of distilled samples from a first set of samples based on a characteristic distribution of the first set of samples, the number of samples in the first set of distilled samples being less than that of the first set of samples, and the first set of samples being associated with a first set of classifications. The method includes acquiring a first set of characteristic representations associated with the first set of distilled samples. The method includes adjusting the first set of characteristic representations so that a distance between characteristic representations associated with the same classification is less than a predetermined threshold. The method includes determining, based on the adjusted first set of characteristic representations, a first set of classification characteristics of the first set of samples and associated with the first set of classifications, the classification characteristics being used to characterize a distribution of characteristic representations of samples having corresponding classifications in the first set of samples.

In a second aspect of the present disclosure, an electronic device is provided. The electronic device includes a processor, and a memory coupled to the processor, the memory having instructions stored therein that, when executed by the processor, cause the device to perform actions, wherein the actions include determining a first set of distilled samples from a first set of samples based on a characteristic distribution of the first set of samples, the number of samples in the first set of distilled samples being less than that of the first set of samples, and the first set of samples being associated with a first set of classifications. The actions also include acquiring a first set of characteristic representations associated with the first set of distilled samples. The actions also include adjusting the first set of characteristic representations so that a distance between characteristic representations associated with the same classification is less than a predetermined threshold. The actions also include determining, based on the adjusted first set of characteristic representations, a first set of classification characteristics of the first set of samples and associated with the first set of classifications, the classification characteristics being used to characterize a distribution of characteristic representations of samples having corresponding classifications in the first set of samples.

In a third aspect of the present disclosure, a computer program product is provided, the computer program product is tangibly stored in a computer-readable medium and includes machine-executable instructions, and the machine-executable instructions, when executed, cause a machine to perform the method according to the first aspect of the present disclosure.

This Summary is provided to introduce the selection of concepts in a simplified form, which will be further described in the Detailed Description below. The Summary is neither intended to identify key features or main features of the present disclosure, nor intended to limit the scope of the present disclosure.

### BRIEF DESCRIPTION OF THE DRAWINGS

The above and other objectives, features, and advantages of the present disclosure will become more apparent from the following description of example embodiments of the present disclosure with reference to the accompanying drawings. In the example embodiments of the present disclosure, the same reference numerals generally represent the same members. In the accompanying drawings,

FIG. 1 shows a schematic diagram of an example environment in which the embodiment of the present disclosure may be implemented;

FIG. 2 shows a flow chart of an example method for sample management according to an embodiment of the present disclosure;

FIG. 3 shows a flow chart of an example method of determining a first set of distilled samples according to an embodiment of the present disclosure;

FIG. 4 shows a schematic diagram of an example process of characteristic representation processing according to some embodiments of the present disclosure;

FIG. 5 shows a flow chart of an example method for performing sample fusion using a first set of classification characteristics; and

FIG. 6 shows a block diagram of an example device that can be used to implement an embodiment of the present disclosure.

### DETAILED DESCRIPTION

The principles of the present disclosure will be described below with reference to several example embodiments shown in the accompanying drawings. Although illustrative embodiments of the present disclosure are shown in the accompanying drawings, it should be understood that these embodiments are described merely to enable those skilled in the art to better understand and then implement the present disclosure, and not to limit the scope of the present disclosure in any way.

The term “include” and variants thereof used herein indicate open-ended inclusion, that is, “including but not limited to.” Unless specifically stated, the term “or” means “and/or.” The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects. Other explicit and implicit definitions may also be included below.

As discussed above, the resulting sample set is usually only used as an alternative sample set for replacing the original training set in model training, and the distilled sample set is not fully utilized.

In order to better utilize the distilled sample set, a solution is provided for reconstructing classification characteristics of an original training sample set using a distilled sample set.

This paragraph briefly describes the solution.

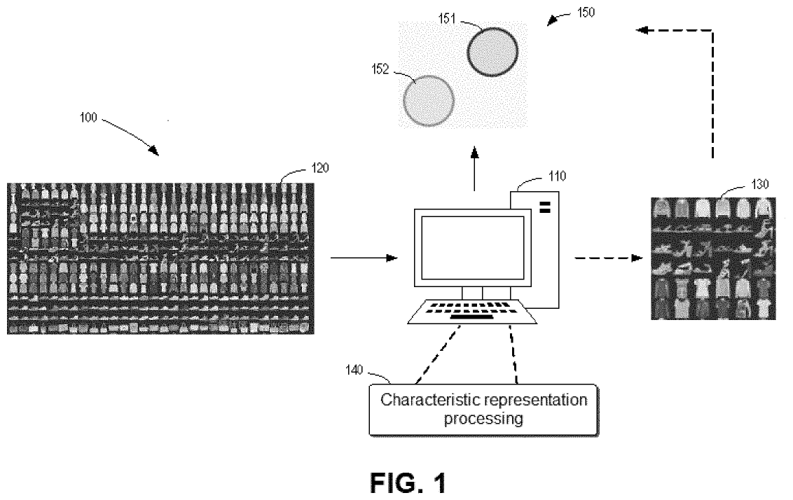

FIG. 1 shows a schematic diagram of example environment 100 in which multiple embodiments of the present disclosure can be implemented. As shown in FIG. 1, environment 100 includes computing device 110, and computing device 110 may, for example, be a device having strong computing power, examples of which include but are not limited to: cloud servers, smartphones, laptops, tablets, desktops, edge computing devices, etc.

According to an embodiment of the present disclosure, computing device 110 can acquire first set of samples 120 and then perform, for example, a distillation algorithm on first set of samples 120 to obtain first set of distilled samples 130. The number of samples in distilled samples 130 is less than the number of samples in first set of samples 120, and distilled samples 130 contain all classifications in a first set of classifications associated with first set of samples 120. A distribution of the samples in each sample classification in distilled samples 130 corresponds to a distribution of the samples in a corresponding sample classification in the first set of samples. First set of samples 120 is associated with the first set of classifications, and there are multiple samples in each classification.

For example, in an example shown in FIG. 1, first set of samples 120 includes a plurality of samples belonging to a men's wear classification, a plurality of samples belonging to a women's wear classification, a plurality of samples belonging to a bag classification, etc. It should be understood that first set of samples 120 and distilled samples 130 shown in FIG. 1 are merely examples, and classifications and quantities of samples and the like therein are not to be understood as limiting the scope of the embodiments of the present disclosure.

After distilled samples 130 are obtained, according to an embodiment of the present invention, computing device 110 can reconstruct, based on distilled samples 130, first set of classification characteristics 150 of first set of samples 120 and associated with the first set of classifications. In the example shown in FIG. 1, the determined first set of classification characteristics 150 includes, for example, men's wear classification characteristic 151 associated with the men's wear classification and women's wear classification characteristic 152 associated with the women's wear classification. The classification characteristic is used to characterize a distribution of characteristic representations of samples having a corresponding classification in the first set of samples. The characteristic representation is a representation form of characteristics associated with samples, and it may be, for example, a characteristic vector. In the example shown in FIG. 1, computing device 110 can acquire characteristic representations associated with distilled samples through characteristic representation processing 140, and can also adjust the characteristic representations.

It should be understood that a classification of specific samples shown in FIG. 1 is merely illustrative and is not intended to limit the present disclosure.

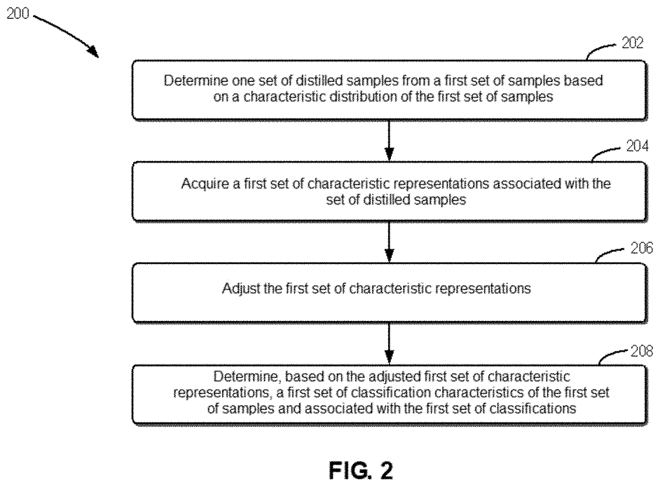

A flow of determining classification characteristics of a first set of samples based on distilled samples will be described in detail below with reference to FIG. 2. FIG. 2 shows a flow chart of example method 200 for sample management according to an embodiment of the present disclosure. Method 200 may be performed, for example, by computing device 110 shown in FIG. 1.

At block 202, computing device 110 determines a first set of distilled samples from a first set of samples based on a characteristic distribution of the first set of samples. The number of samples in the first set of distilled samples is less than that of the first set of samples, and the first set of samples is associated with a first set of classifications.

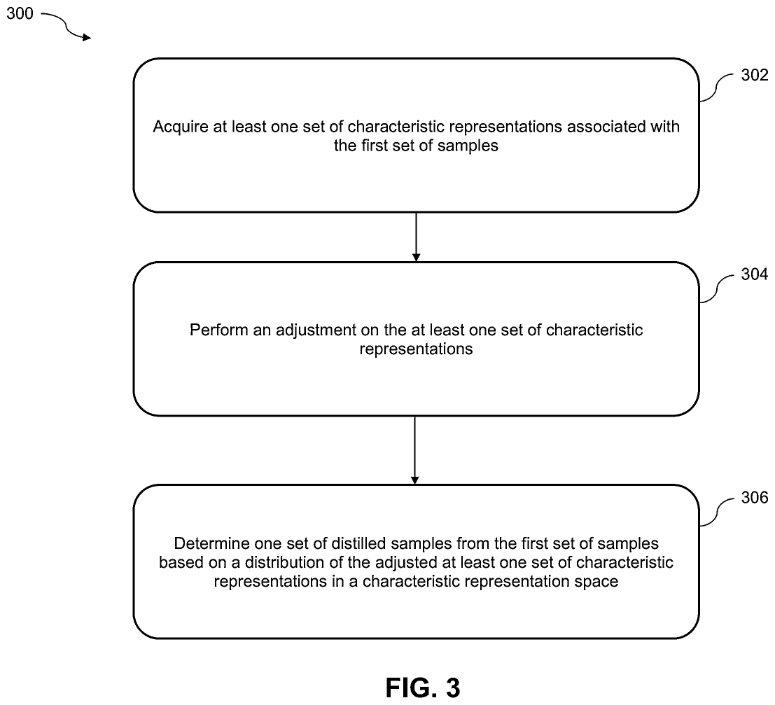

For example, the number of samples in the first set of samples may be 6000, while the number of samples in the first set of distilled samples is 10. It should be understood that such specific numbers are merely illustrative. Accordingly, the first set of distilled samples is also associated with the first set of classifications. The characteristic distribution of the first set of samples is a distribution of characteristics associated with samples in the first set of samples in a particular characteristic space. A detailed process of determining the first set of distilled samples will be described below with reference to FIG. 3.

FIG. 3 shows a flow chart of example method 300 for determining a first set of distilled samples according to an embodiment of the present disclosure. Method 300 may be performed, for example, by computing device 110 in FIG. 1.

As shown in FIG. 3, at block 302, computing device 110 can acquire at least one set of characteristic representations associated with a first set of samples.

At block 304, computing device 110 performs an adjustment on the at least one set of characteristic representations. For example, the at least one set of characteristic representations can be obtained and adjusted by characteristic representation processing 140 as discussed above.

At block 306, computing device 110 determines a first set of distilled samples from the first set of samples based on a distribution of the adjusted at least one set of characteristic representations in a characteristic representation space. In some embodiments, samples associated with characteristic representations that can sufficiently characterize the distribution may be selected based on characteristics of the distribution. For example, when a distribution of the at least one set of characteristics in the characteristic representation space is a circle, it is possible to select samples that are associated with the characteristic representations at the circle center and the circumference.

It should be understood that the determination of the first set of distilled samples mentioned herein is merely illustrative. All methods that can acquire distilled samples can be applied here. Returning to FIG. 2, at block 204, computing device 110 acquires a first set of characteristic representations associated with the first set of distilled samples. For example, the characteristic representations may be characteristic vectors. Characteristic representations associated with samples can be extracted by a pre-trained model.

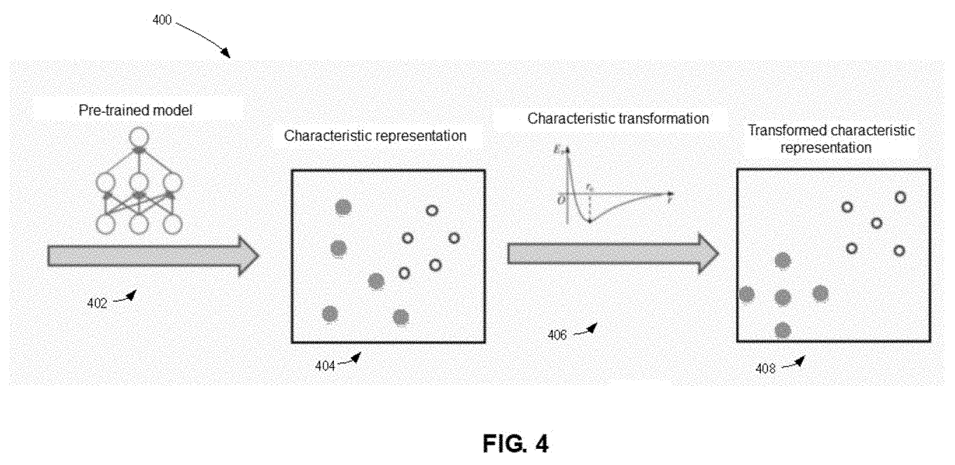

At block 206, computing device 110 adjusts the first set of characteristic representations so that a distance between characteristic representations associated with the same classification is less than a predetermined threshold. In some embodiments, the first set of characteristic representations may be adjusted so that a distance between characteristic representations associated with different classifications is greater than a predetermined threshold. Next, acquisition and adjustment of characteristic representations will be described in detail with reference to FIG. 4.

FIG. 4 shows a schematic diagram of example process 400 of acquisition and processing of characteristic representations of an embodiment of the present disclosure. Process 400 may be performed, for example, by computing device 110 shown in FIG. 1. Process 400 corresponds to, for example, characteristic representation processing 140 in FIG. 1. After one set of samples is acquired, computing device 110 can extract characteristic representations 404 from this set of samples using pre-trained model 402. Characteristic representations 404 are, for example, characteristic vectors in a first characteristic space. In the example of FIG. 4, only characteristic representations of two classifications are shown by way of example, that is, a first classification (represented by a solid circle) and a second classification (represented by a hollow circle). It should be understood that all samples obtained will be processed during process 400. In 404, it can be seen that characteristic representations associated with the same classification are relatively scattered. Subsequently, computing device 110 performs characteristic transformation 406 on characteristic representations 404, thereby obtaining transformed characteristic representations 408. In 408, the characteristic representations associated with the same classification are centralized. The characteristic transformation is, for example, a spatial transformation that transforms characteristic vectors from a characteristic space to a new characteristic space, and the spatial transformation is associated with the transformation. In some embodiments, the characteristic transformation in the form of transformation matrix W_{T} can be obtained by optimizing the following function:

$$L = {\sum }_{i}^{N} {\sum }_{j}^{N - 1} [ \frac{1}{{( {d}_{ij} + λ )}^{2}} - \frac{1}{{( {d}_{ij} + λ )}^{3}} ] \qquad ( 1 )$$

where d_{i,j}=dis(W_{T}fᵢ, W_{T}fⱼ), dis( ) represents a measure of distances, such as a Euclidean distance in the Euclidean space, N is data of samples compared, and λ is a settable hyper-parameter. By back propagation of L, W_{T} can be determined. After adjustment using W_{T}, a distance of characteristic representations associated with different classifications is greater than a predetermined threshold, so that distributions of characteristic representations associated with different classifications will not overlap.

In some embodiments, characteristic transformation may also include other adjustments. For example, characteristic representations may also be adjusted so that characteristic representations associated with the same classification meet a predetermined distribution type. For example, using a Tukey power transformation, characteristic representations associated with the same classification may be made to meet a Gaussian distribution.

Returning to FIG. 2, at block 208, computing device 110 determines, based on the adjusted first set of characteristic representations, a first set of classification characteristics of the first set of samples and associated with the first set of classifications. Since the distribution of characteristic representations associated with the first set of distilled samples as discussed above can sufficiently reflect the distribution of characteristic representations associated with the first set of samples, the first set of classification characteristics of the first set of samples and associated with the first set of classifications may be reconstructed based on the distribution of the first set of characteristic representations.

In some embodiments, computing device 110 can first acquire one set of distillation classification characteristics of the adjusted first set of characteristic representations and associated with the first set of classifications, and then determine the first set of classification characteristics based on this set of distillation classification characteristics. In some embodiments, for each classification, classification characteristics of the adjusted first set of characteristic representations meet a Gaussian distribution. In this case, the first set of classification characteristics of the first set of samples may be calculated by using, for example, the unscented Kalman filtering algorithm. For each classification, 2n+1 sampling points are selected based on dimensionality n of the characteristic representations, where the first sampling point S[0]=μ, and the subsequent 2n sampling points are selected by the following formula:

$$𝒮 [ i ] = \{ \begin{matrix}μ + {V}_{i} & i = 1 , … , n - 1 \\ μ - {V}_{i - n} & i = n , … , 2 n\end{matrix} \qquad ( 2 )$$

where V=\sqrt{(n+λ)Σ} is a variance matrix, represents the i-th column of the variance matrix, λ is a presettable zoom parameter, and Σ is a covariance matrix, that is derived by the adjusted first set of characteristic representations. Thereafter, for each sampling point, a weight ωₘ^{[i]} for a mean value and a weight ω_{c}^{[i]} for a variance are calculated by the following formulas, respectively:

$${ω}_{m}^{[ i ]} = \{ \begin{matrix}\frac{λ}{n + λ} & i = 0 \\ \frac{1}{2 ( n + λ )} , & i = 1 , … , 2 n\end{matrix} \qquad ( 3 )$$

$${ω}_{c}^{[ i ]} = \{ \begin{matrix}{ω}_{m}^{[ 0 ]} + H & i = 0 \\ \frac{1}{2 ( n + λ )} , & i = 1 , … , 2 n\end{matrix} \qquad ( 4 )$$

where, λ=α²(n+k)−n, H=1−α2+β, the presettable parameter α∈(0, 1] with k≥0, and the parameter β is preferably 2. Finally, the classification characteristics, namely, the mean value and covariance, of the classification characteristics can be calculated, for example, through the weights:

$${μ}^{′} = {\sum }_{\dot{t} = 0}^{2 n} {ω}_{m}^{[ i ]} S [ i ] . \qquad ( 5 )$$

$$cov = {\sum }_{i = 0}^{2 n} {ω}_{c}^{[ i ]} ( S [ i ] - {μ}^{′} ) {( S [ i ] - {μ}^{′} )}^{T} . \qquad ( 6 )$$

By performing method 200, a set of distilled samples, of which the number is small, can be utilized to determine a first set of samples, of which the original number is large, which reduces the calculation burden and speeds up the calculation.

In some embodiments, the obtained classification characteristics can be used directly to train a classifier for classifying target samples. For example, after target samples are obtained, characteristic representations associated with the target samples can be determined, and then a target classification associated with the target samples in the first set of classifications is determined based on a comparison between the characteristic representations and the first set of classification characteristics.

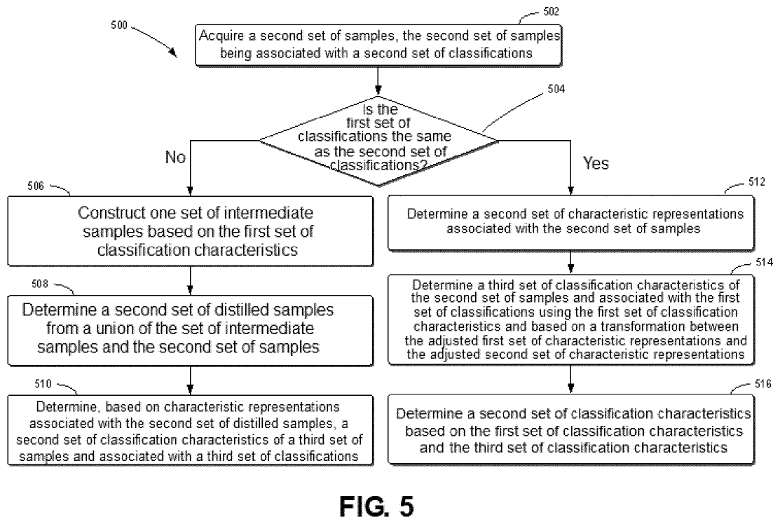

In some embodiments, the first set of classification characteristics of the first set of samples can be further utilized after reconstruction. FIG. 5 shows a flow chart of example method 500 for performing sample fusion using a first set of classification characteristics. Method 500 may be performed, for example, by computing device 110 in FIG. 1.

At block 502, computing device 110 acquires a second set of samples, the second set of samples being associated with a second set of classifications.

At block 504, computing device 110 determines whether the first set of classifications is the same as the second set of classifications.

If the first set of classifications is different from the second set of classifications, the method proceeds to block 506.

At block 506, computing device 110 constructs one set of intermediate samples based on the first set of classification characteristics. For example, through predetermined rules, a certain number of characteristic representations can be selected from the distribution characterized by the first set of classification characteristics as the intermediate samples. In some embodiments, the intermediate samples are obtained by upsampling. For example, random noise can be added.

At block 508, computing device 110 determines a second set of distilled samples from a union of the set of intermediate samples and the second set of samples.

At block 510, computing device 110 determines, based on characteristic representations associated with the second set of distilled samples, a second set of classification characteristics of a third set of samples and associated with a third set of classifications. The third set of samples is a union of the first set of samples and the second set of samples, and the third set of classifications is a union of the first set of classifications and the second set of classifications. In some embodiments, the second set of distilled samples can be obtained using method 300 as discussed above.

Relatively, if the first set of classifications is the same as the second set of classifications, the method proceeds to block 512.

At block 512, computing device 110 determines a second set of characteristic representations associated with the second set of samples. For example, the second set of characteristic representations can be obtained using characteristic representation processing 140 as discussed above.

At block 514, computing device 110 determines a third set of classification characteristics of the second set of samples and associated with the first set of classifications using the first set of classification characteristics and based on a transformation between the adjusted first set of characteristic representations and the adjusted second set of characteristic representations. It should be understood that results of adjustments may be different for different input samples. At this moment, the first set of characteristic representations and the second set of characteristic representations need to be transformed into the same characteristic space. In some embodiments, for example, by equalizing a mean value μ₁^{[c]} of characteristic representations associated with one classification in the first set of characteristic representations to a mean value μ₂^{[c]} of characteristic representations associated with the same classification in the second set of characteristic representations of the second set of samples, a corresponding transformation matrix can be obtained θ. Thus, a third set of classification characteristics (μ₂^{[c]}, cov₂^{[c]}) of the second set of samples can be calculated based on the first set of classification characteristics (μ₁^{[c]}, cov₁^{[c]}) of the first set samples and using the following formulas:

μ₂^{[c]}=μ₁^{[c]} (7)

cov₂^{[c]}=θ cov₁^{[c]}θ^{T} (8)

At block 516, computing device 110 determines the second set of classification characteristics based on the first set of classification characteristics and the third set of classification characteristics. Continuing with the embodiment at block 514, the second set of classification characteristics (μ₃^{[c]}, cov₃^{[c]}) of the third set of samples, namely, a union of the first set of samples and the second set of samples, can be calculated based on the first set of classification characteristics (μ₁^{[c]}, cov₁^{[c]}) and the third set of classification characteristics (μ₂^{[c]}, cov₂^{[c]}) by using the following formulas:

$${μ}_{2}^{[ c ]} = {μ}_{1}^{[ c ]} = {μ}_{3}^{[ c ]} \qquad ( 9 )$$

$${cov}_{3}^{[ c ]} = {cov}_{1}^{{[ c ]}^{2}} - \frac{{cov}_{2}^{{[ c ]}^{4}}}{{cov}_{1}^{{[ c ]}^{2}} + {cov}_{2}^{{[ c ]}^{2}}} . \qquad ( 10 )$$

By using reconstructed distribution characteristics to calculate distribution characteristics after new samples are added, the analysis and calculation of all samples can be omitted, which greatly reduces the amount of calculation and improves efficiency. An accurate and efficient solution is provided for the sample analysis field where new samples are added constantly.

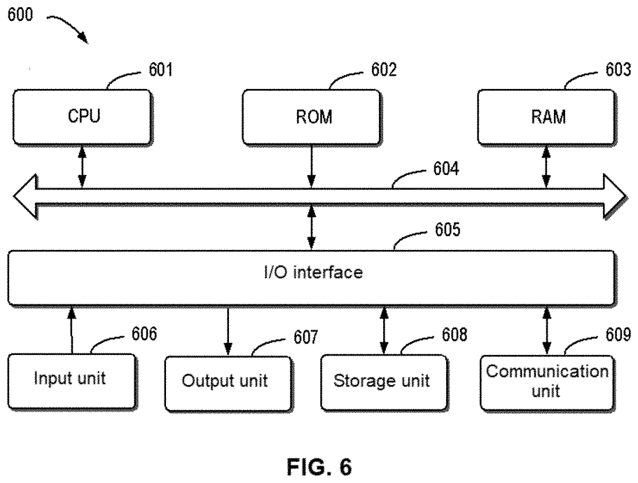

FIG. 6 shows a schematic block diagram of example device 600 that can be used to implement the embodiments of the present disclosure. As shown in FIG. 6, device 600 includes central processing unit (CPU) 601 that may perform various appropriate actions and processing according to computer program instructions stored in read-only memory (ROM) 602 or computer program instructions loaded from storage unit 608 to random access memory (RAM) 603. Various programs and data required for the operation of device 600 may also be stored in RAM 603. CPU 601, ROM 602, and RAM 603 are connected to each other through bus 604. Input/output (I/O) interface 605 is also connected to bus 604.

Multiple components in device 600 are connected to I/O interface 605, including: input unit 606, such as a keyboard and a mouse; output unit 607, such as various types of displays and speakers; storage unit 608, such as a magnetic disk and an optical disc; and communication unit 609, such as a network card, a modem, and a wireless communication transceiver. Communication unit 609 allows device 600 to exchange information/data with other devices via a computer network, such as the Internet, and/or various telecommunication networks.

The various processes and processing described above, for example, methods 200, 300, and 500, may be performed by CPU 601. For example, in some embodiments, method 200, method 300, and method 500 may be implemented as a computer software program that is tangibly included in a machine-readable medium such as storage unit 608. In some embodiments, part or all of the computer program may be loaded and/or installed onto device 600 via ROM 602 and/or communication unit 609. When the computer program is loaded to RAM 603 and executed by CPU 601, one or more actions of method 200, 300, and/or 500 described above may be executed.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may hold and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read only memory (EPROM or flash memory), a static random access memory (SRAM), a portable compact disk read only memory (CD-ROM), a digital versatile disk (DVD), a memory stick, a floppy disk, a mechanical encoding device such as a punch card or a protruding structure within a groove having instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in the computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or more programming languages, the programming languages including object-oriented programming language such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

Various aspects of the present disclosure are described here with reference to flow charts and/or block diagrams of the method, the apparatus (system), and the computer program product implemented according to the embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in an inverse order, which depends on involved functions. It should be further noted that each block in the block diagrams and/or flow charts as well as a combination of blocks in the block diagrams and/or flow charts may be implemented using a special hardware-based system that executes specified functions or actions, or implemented using a combination of special hardware and computer instructions.

Example embodiments of the present disclosure have been described above. The above description is illustrative, rather than exhaustive, and is not limited to the disclosed various embodiments. Numerous modifications and alterations will be apparent to those of ordinary skill in the art without departing from the scope and spirit of the illustrated embodiments. The selection of terms used herein is intended to best explain the principles and practical applications of the various embodiments or the improvements to technologies on the market, so as to enable persons of ordinary skill in the art to understand the embodiments disclosed herein.

What is claimed is:

1. A method for sample management, comprising:
determining a first set of distilled samples from a first set of samples based on a characteristic distribution of the first set of samples, the number of samples in the first set of distilled samples being less than that of the first set of samples, and the first set of samples being associated with a first set of classifications;
acquiring a first set of characteristic representations associated with the first set of distilled samples;
adjusting the first set of characteristic representations so that a distance between characteristic representations associated with the same classification is less than a predetermined threshold; and
determining, based on the adjusted first set of characteristic representations, a first set of classification characteristics of the first set of samples and associated with the first set of classifications, the classification characteristics being used to characterize a distribution of characteristic representations of samples having corresponding classifications in the first set of samples.

2. The method according to claim 1, wherein determining the first set of classification characteristics of the first set of samples and associated with the first set of classifications comprises:
acquiring one set of distillation classification characteristics of the adjusted first set of characteristic representations and associated with the first set of classifications; and
determining the first set of classification characteristics based on one set of distillations and based on classification characteristics of the first set of characteristic representations.

3. The method according to claim 1, further comprising:
acquiring a second set of samples, the second set of samples being associated with a second set of classifications; and
determining, at least based on the first set of classification characteristics, a second set of classification characteristics of a third set of samples and associated with a third set of classifications, the third set of samples being a union of the first set of samples and the second set of samples, and the third set of classifications being a union of the first set of classifications and the second set of classifications.

4. The method according to claim 3, wherein determining the second set of classification characteristics at least based on the first set of classification characteristics comprises:
constructing one set of intermediate samples based on the first set of classification characteristics in response to determining that the first set of classifications is different from the second set of classifications;
determining a second set of distilled samples from a union of the set of intermediate samples and the second set of samples; and
determining, based on characteristic representations associated with the second set of distilled samples, the second set of classification characteristics of the third set of samples and associated with the third set of classifications.

5. The method according to claim 3, wherein determining the second set of classification characteristics at least based on the first set of classification characteristics comprises:
determining a second set of characteristic representations associated with the second set of samples in response to determining that the first set of classifications is the same as the second set of classifications;
determining a third set of classification characteristics of the second set of samples and associated with the first set of classifications using the first set of classification characteristics and based on a transformation between the adjusted first set of characteristic representations and the adjusted second set of characteristic representations; and
determining the second set of classification characteristics based on the first set of classification characteristics and the third set of classification characteristics.

6. The method according to claim 1, further comprising:
acquiring target samples and determining characteristic representations associated with the target samples;
determining target classifications associated with the target samples from the first set of classifications based on a comparison between the characteristic representations and the first set of classification characteristics.

7. The method according to claim 1, wherein the classification characteristics comprise a mean value and a covariance of the distribution of characteristic representations of samples having corresponding classifications in the first set of samples.

8. The method according to claim 1, wherein determining the first set of distilled samples from the first set of samples based on the characteristic distribution of the first set of samples comprises:
acquiring at least one set of characteristic representations associated with the first set of samples;
performing an adjustment on the at least one set of characteristic representations such that the at least one set of characteristic representations is transformed into a characteristic representation space; and
determining the first set of distilled samples from the first set of samples based on a distribution of the adjusted at least one set of characteristic representations in the characteristic representation space.

9. An electronic device, comprising:
a processor; and
a memory coupled to the processor, the memory having instructions stored therein that, when executed by the processor, cause the device to execute actions comprising:
determining a first set of distilled samples from a first set of samples based on a characteristic distribution of the first set of samples, the number of samples in the first set of distilled samples being less than that of the first set of samples, and the first set of samples being associated with a first set of classifications;
acquiring a first set of characteristic representations associated with the first set of distilled samples;
adjusting the first set of characteristic representations so that a distance between characteristic representations associated with the same classification is less than a predetermined threshold; and
determining, based on the adjusted first set of characteristic representations, a first set of classification characteristics of the first set of samples and associated with the first set of classifications, the classification characteristics being used to characterize a distribution of characteristic representations of samples having corresponding classifications in the first set of samples.

10. The electronic device according to claim 9, wherein determining the first set of classification characteristics of the first set of samples and associated with the first set of classifications comprises:
acquiring classification characteristics of the adjusted first set of characteristic representations;
determining the first set of classification characteristics using the unscented Kalman filtering algorithm and based on the classification characteristics of the first set of characteristic representations.

11. The electronic device according to claim 9, wherein the actions further comprise:
acquiring a second set of samples, the second set of samples being associated with a second set of classifications; and
determining, at least based on the first set of classification characteristics, a second set of classification characteristics of a third set of samples and associated with a third set of classifications, the third set of samples being a union of the first set of samples and the second set of samples, and the third set of classifications being a union of the first set of classifications and the second set of classifications.

12. The electronic device according to claim 11, wherein determining the second set of classification characteristics at least based on the first set of classification characteristics comprises:
constructing one set of intermediate samples based on the first set of classification characteristics in response to determining that the first set of classifications is different from the second set of classifications;
determining a second set of distilled samples from a union of the set of intermediate samples and the second set of samples; and
determining, based on characteristic representations associated with the second set of distilled samples, the second set of classification characteristics of the third set of samples and associated with the third set of classifications.

13. The electronic device according to claim 11, wherein determining the second set of classification characteristics at least based on the first set of classification characteristics comprises:
determining a second set of characteristic representations associated with the second set of samples in response to determining that the first set of classifications is the same as the second set of classifications;
determining a third set of classification characteristics of the second set of samples and associated with the first set of classifications using the first set of classification characteristics and based on a transformation between the adjusted first set of characteristic representations and the adjusted second set of characteristic representations; and
determining the second set of classification characteristics based on the first set of classification characteristics and the third set of classification characteristics.

14. The electronic device according to claim 9, wherein the actions further comprise:
acquiring target samples and determining characteristic representations associated with the target samples;
determining target classifications associated with the target samples from the first set of classifications based on a comparison between the characteristic representations and the first set of classification characteristics.

15. The electronic device according to claim 9, wherein the classification characteristics comprise a mean value and a covariance of the distribution of characteristic representations of samples having corresponding classifications in the first set of samples.

16. The electronic device according to claim 9, wherein determining the first set of distilled samples from the first set of samples based on the characteristic distribution of the first set of samples comprises:
acquiring at least one set of characteristic representations associated with the first set of samples;
performing an adjustment on the at least one set of characteristic representations such that the at least one set of characteristic representations are transformed into a characteristic representation space; and
determining the first set of distilled samples from the first set of samples based on a distribution of the adjusted at least one set of characteristic representations in the characteristic representation space.

17. A computer program product tangibly stored in a computer-readable medium and comprising machine-executable instructions, wherein the machine-executable instructions, when executed, cause a machine to perform a method for sample management, the method comprising:
determining a first set of distilled samples from a first set of samples based on a characteristic distribution of the first set of samples, the number of samples in the first set of distilled samples being less than that of the first set of samples, and the first set of samples being associated with a first set of classifications;
acquiring a first set of characteristic representations associated with the first set of distilled samples;
adjusting the first set of characteristic representations so that a distance between characteristic representations associated with the same classification is less than a predetermined threshold; and
determining, based on the adjusted first set of characteristic representations, a first set of classification characteristics of the first set of samples and associated with the first set of classifications, the classification characteristics being used to characterize a distribution of characteristic representations of samples having corresponding classifications in the first set of samples.

18. The computer program product according to claim 17, wherein determining the first set of classification characteristics of the first set of samples and associated with the first set of classifications comprises:
acquiring one set of distillation classification characteristics of the adjusted first set of characteristic representations and associated with the first set of classifications; and
determining the first set of classification characteristics based on one set of distillations and based on classification characteristics of the first set of characteristic representations.

19. The computer program product according to claim 17, further comprising:
acquiring a second set of samples, the second set of samples being associated with a second set of classifications; and
determining, at least based on the first set of classification characteristics, a second set of classification characteristics of a third set of samples and associated with a third set of classifications, the third set of samples being a union of the first set of samples and the second set of samples, and the third set of classifications being a union of the first set of classifications and the second set of classifications.

20. The computer program product according to claim 19, wherein determining the second set of classification characteristics at least based on the first set of classification characteristics comprises:
constructing one set of intermediate samples based on the first set of classification characteristics in response to determining that the first set of classifications is different from the second set of classifications;
determining a second set of distilled samples from a union of the set of intermediate samples and the second set of samples; and
determining, based on characteristic representations associated with the second set of distilled samples, the second set of classification characteristics of the third set of samples and associated with the third set of classifications.
